(19) United States
(12) Patent Application Publication
(10) Pub. No.: US 2004/0216940 A1
(43) Pub. Date: Nov. 4, 2004

(54) Method and device for increasing the safety of operation of an electrical component

(76) Inventor: Bernhard Forstl, Ihrlerstein (DE)

Correspondence Address: Andreas Grubert, Baker Bolts L.L.P., 910 Louisiana, One Shell Plaza, Houston, TX, 77002-4995, US

(21) Appl. No.: 10/821,782

(22) Filed: Apr. 9, 2004

(30) Foreign Application Priority Data
Apr. 11, 2003 (DE) DE10316805.2

(51) Int. Cl. B60R 21/00

(52) U.S. Cl. 180/271

(57) ABSTRACT

The diagnostics for a switched high-current or safety-relevant load (M) are extended to include active detection of a change in switching state of the load (M) independently of the instant of active actuation by the microcontroller (μC) and/or a superordinate control unit (SG). The diagnostic feedback is preferably applied to a “wake up” interrupt input of the microcontroller (μC). This allows active diagnostics in the event of a state change of the load (M), even if the controller (μC) is in power-down mode (μCₛₜₒₚ).

### PRIORITY

This application claims priority to German application no. 103 16 805.2 filed Apr. 11, 2003.

### TECHNICAL FIELD OF THE INVENTION

The invention relates to a method for increasing the safety of operation of one or more electrical components, particularly electrical components in a motor vehicle.

### BACKGROUND OF THE INVENTION

In the context of the present invention, the term “electrical components” should also be taken to mean electronic components. Electrical protection devices for increasing the safety of operation of electrical components have long been known. However, the common feature of all said designs of electrical protection devices is that, due to the limited mounting space available, they are increasingly difficult to integrate into circuits e.g. as fuses, even in the form of chip or microfuses, for the protection of power supply and supervisory control functions.

A particularly serious situation arises within an automotive electronic system or a vehicle controller unit. This will now be discussed in greater detail by way of example. In the automotive field, exacting requirements are placed on passenger and driver safety. The range of power functions to be electrically protected, particularly in private motor vehicles, will thus continue to grow apace in the near future, as will the number of vehicle controller units. However, space is greatly at a premium for such units, which means that integrating electrical protection measures into controller units is already posing major problems in terms of placement and space requirement.

Protection devices are much more complex than simply providing overload protection, i.e. protection against excessively high currents, voltages, temperatures, etc. Such protection devices are also much more expensive to implement than e.g. a fuse. These protection devices are usually implemented as microcontroller circuits whose task is also to monitor the operation of connected loads or loads to be switched. For example, the motors of a central locking system inside a motor vehicle constitute loads which are only very briefly actuated, usually for only about 400 ms, as low-impedance loads at comparatively high currents in the application. This brief actuation time is sufficient to place a vehicle's central locking system in the required state. Because of the brief actuation time, the cable cross-sections, the electrical components, their design and sizing or, generally speaking, the cost/complexity of dissipating the heat associated with high current flow, can nevertheless be kept low.

In known and previously published safety devices of the applicant, diagnostics for a high-current load to be switched or of a safety-relevant load are performed either before switch-in of the load or immediately after activation of the corresponding output on a controller, the controller also only being switched active during the time in which the relevant load has to be actuated. A malfunction occurring between the two specified instants essentially cannot be detected. An unknown disturbance can therefore lead to safety-critical operating states and e.g. cause a cable fire in the vehicle, or bring about an unwanted and uncontrolled activation of safety-relevant actuators.

### SUMMARY OF THE INVENTION

The object of the present invention is to create an improved device and a method for increasing the safety of operation of one or more electrical components, taking into account the abovementioned fault mechanisms.

This object can be achieved by a method for increasing the safety of operation of an electrical component, in particular of electrical components in a vehicle, comprising the steps of:

actuating a load via a microcontroller,

detecting actively a change in the switching state of a relevant load,

performing diagnostics irrespective of the instant of actuation of the load by the microcontroller and/or by a superordinate control unit.

A diagnostic feedback can be applied to a wake-up interrupt input of the microcontroller or to an input for a non-maskable interrupt as diagnostic readback port. Switch-in or disconnection of a load can be performed by a vehicle electrical system control unit, wherein a central locking motor preferably being actuated as the load. Diagnostic means can be used to determine whether a fault state can be eliminated by the microcontroller, remedial action being initiated by a superordinate control unit if the microcontroller fails.

The object can furthermore be achieved by a device for increasing the safety of operation of an electrical component in a circuit, particularly of electrical components in a vehicle, wherein a load is connected to a microcontroller for actuation, comprising means of actively detecting a change in switching state of the load which are designed to act, independently of the instant of active triggering of a microcontroller, upon the microcontroller and/or a superordinate control unit.

The device may further comprise means for actuating a load via a microcontroller, and means for performing diagnostics irrespective of the instant of actuation of the load by the microcontroller and/or by a superordinate control unit. The device may also comprise a vehicle electrical system control unit for switching in or disconnecting the load as specified by the microcontroller. The additional hardware compared to known system can be essentially combined in the microcontroller. Diagnostic means can be provided for identifying a fault state which cannot be eliminated by the microcontroller, and said diagnostic can also take remedial action.

The object can furthermore be achieved by a device for increasing the safety of operation of an electrical component, in particular of electrical components in a vehicle, comprising means for actuating a load via a microcontroller, means for detecting actively a change in the switching state of a relevant load, and means for performing diagnostics irrespective of the instant of actuation of the load by the microcontroller and/or by a superordinate control unit.

A diagnostic feedback can be applied to a wake-up interrupt input of the microcontroller or to an input for a non-maskable interrupt as diagnostic readback port. The device may comprise a vehicle electrical system control unit for switch-in or disconnection of a load, and a central locking motor preferably being actuated as the load. The device may also comprise a superordinate control unit coupled with said means for performing diagnostic to determine whether a fault state can be eliminated by the microcontroller, wherein remedial action being initiated by the superordinate control unit if the microcontroller fails.

A device for increasing the safety of operation of electrical components as a load consequently has, according to the invention, detection means for actively detecting a change in the switching state of a relevant load which, irrespective of the instant of active actuation by a microcontroller, act upon the microcontroller and/or a superordinate supervisory control unit.

In a further development of the invention, a diagnostic feedback loop to a “wake up” interrupt input is inserted, preferably an interrupt of the microcontroller as supervisory control device. In one embodiment of the invention, an input for a non-maskable interrupt is used as the diagnostic readback port for diagnostic feedback. Alternatively feedback is sent via a bus to a superordinate control instance via a state change. As a widely used bus standard for motor vehicles, the CAN bus is an obvious choice, having the possibility of prioritizing certain messages.

In addition, diagnostics are advantageously performed, it being established whether the fault present can be cleared at all by the microcontroller. In the event of a major fault which cannot be corrected by the microcontroller, shutdown or other remedial action is performed by an instance superordinate to the microcontroller.

Further advantageous embodiments are detailed in the relevant sub-claims.

### BRIEF DESCRIPTION OF THE DRAWINGS

Further features and advantages of the present invention will emerge from the following more detailed description of preferred embodiments with reference to the associated schematics in which:

FIG. 1: shows a schematic diagram of the circuit according to the invention;

FIG. 2: shows a time response in the event of a disturbance;

FIG. 3: shows an extended circuit with a disturbance that cannot be actively eliminated;

FIG. 4: shows a schematic drawing of a circuit according to the prior art and

FIG. 5: shows a time response of the circuit according to FIG. 4 in the event of a disturbance.

### PREFERRED EMBODIMENTS OF THE INVENTION

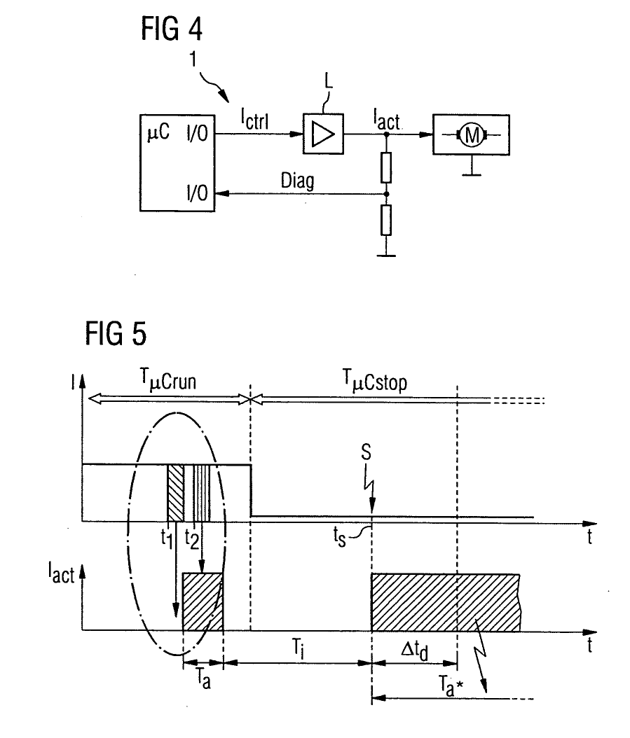

A circuit 1 according to the prior art comprises a microcontroller μC as controlling element which actuates a load via a power amplifier or a switch L by means of a control signal l_{crtl}, see FIG. 4. The load, in this case a motor M, receives an actuating signal l_{act}. This actuating signal l_{act} is here partially fed back to the microcontroller μC via a voltage divider as a diagnostic signal Diag, thereby confirming that the control signal l_{crtl} has also been correctly implemented by the actuating signal l_{act} to switch on the motor M.

A circuit 1 of this kind is used in motor vehicles as a known means of actuating and monitoring central locking motors M, said motors M constituting a low-impedance load actuated only briefly with high current flow. However, the short actuation time of e.g. 400 ms is sufficient to place the vehicle's central locking in the required state. Because of the short actuation time, the overall design ratings for the cable cross sections and electrical components in respect of heat dissipation can be kept low, even though relatively high currents flow when the circuit is in an active state.

Diagnostics for a motor M as a “high-current load” to be switched are performed by the microcontroller μC in a time window enclosed by the dash-dotted line in FIG. 5. The graphs in FIG. 5 represent the signal response in the microcontroller μC with reference to a through-flowing current I, and the waveform of the actuating signal l_{act} applied to the load M.

The signal response in the microcontroller μC shows that in general a distinction must be drawn between periods T_{μCrun} when the microcontroller μC is in active mode and periods in which the microcontroller μC is in idle mode. Periods in idle mode are denoted by T_{μCstop}. Accordingly, diagnostics for the motor M are in this case performed at an instant t₁ prior to switch-in of the load M and at an instant t₂ immediately after activation of the corresponding output on the controller μC. In both cases the microcontroller μC must be switched active or started up. Alternatively, one of these diagnostic states may be considered sufficient at least according to the prior art. These possibilities will not be pursued further here.

When the microcontroller μC is started up, the load M itself is switched active in a monitored and controlled manner for a time interval Tₐ by means of control signals l_{crtl} (not shown). This active phase Ta of 400 ms for the drive motor M of a central locking system is followed by an idle phase Tᵢ with the load M deactivated. In the idle phase Tᵢ, the microcontroller μC itself is also shut down, as indicated in the graph in FIG. 5 by the section T_{μCstop} with low current flow through the microcontroller μC.

At the instant t_{S}, an external disturbance S causes unwanted activation of the load M over a period Tₐ*. This disturbance S is in this case assumed to be a magnetic pulse in the control signal l_{crtl}. This comparatively minor disturbance S is amplified in the circuit according to FIG. 4 by the power amplifier L. The disturbance signal S is therefore indistinguishable from a wanted control signal l_{crtl} and so activates the load M. This malfunction based on a relatively slight magnetic disturbance S does not occur between the instants t₁ and t₂ but during the period T_{μCstop} in which the microcontroller μC as monitoring device is itself also shut down. This malfunction cannot therefore be detected.

This can result in a safety-critical state in the vehicle: a high current is now permanently applied to the load M with the loss of much electrical energy. On the other hand, the entire motor vehicle electrical system is not designed for continuous loading of this kind in terms of heat dissipation. When a time interval Δt_{d} is exceeded, permanent damage to one or more electrical and electronic devices is a possibility. This damage is indicated by the flash symbol in FIG. 5. However, even more serious damage, such as a cable fire in the vehicle or activation of other safety-relevant actuators, cannot be ruled out.

This state is also unsatisfactory in terms of break-in and anti-theft protection: a control system of a safety-relevant load, such as here the actuation of a central locking motor M, can be very effectively rendered inoperative by a magnetic pulse of approximately 400 ms duration. The vehicle would have been opened by external tampering e.g. at a door at least. Such tampering could also be carried out non-destructively, which means that it might not be provable particularly for insurance purposes.

The above type of fault mechanism has not hitherto been considered. Consequently, such malfunctions are also not covered by known protection devices. Electrical safety requirements and improved anti-tampering protection on a vehicle call for a remedy here.

Diagnostics for the switched high-current and/or safety-relevant loads M are now extended to include active detection of a change in the switching state of a relevant load M, said diagnostics being performed independently of an instant of active actuation of the load M by the microcontroller μC. However, the load M can also additionally continue to be diagnosed immediately prior to switch-in and/or immediately after switch-in, although this will not be examined in further detail here.

The diagnostic feedback is applied to a so-called “wake up” interrupt input IRQ of the microcontroller μC. This allows active diagnostics for a state change of the load M to be performed even if the controller μC is in stop or power-down mode μCₛₜₒₚ during the time interval T_{μCstop}.

In addition to the wake-up interrupt inputs IRQ on the controller μC, an input/output I/O for a so-called non-maskable interrupt, NMI for short, is suitable as the diagnostic readback port. Using the NMI interrupt is extremely effective and advantageous, as this interrupt routine cannot be software masked or disabled. It is therefore executed in every case in spite of any miscellaneous processor malfunctions present.

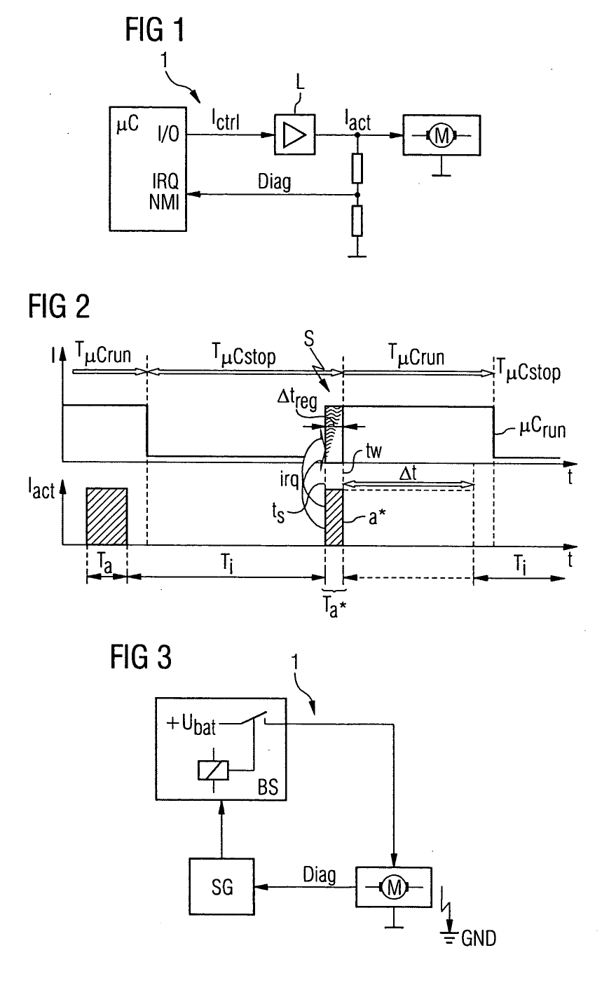

A modification of the schematic diagram of a circuit 1 according to the prior art as shown in FIG. 4 is reproduced in FIG. 1. Note here that wake-up interrupt inputs IRQ and also inputs for non-maskable interrupts NMI have already been implemented on known microcontrollers or their chip families and are therefore available at acceptable extra cost.

A time response of the circuit according to FIG. 1 is reproduced in the diagram in FIG. 2. The description of this time response will here be limited to an interference scenario: while the microcontroller 1C is in stop or power down mode μCₛₜₒₚ, the external disturbance S as a magnetic pulse or other parasitic in turn acts upon the circuit 1 at instant t_{S}. The load M is activated independently of the microcontroller μC as described above in connection with FIG. 5, only this change of state of the load M, in contrast to devices according to the prior art, now initiates an interrupt IRQ which is immediately forwarded to the corresponding input of the microcontroller μC. Within a very short time interval Δt_{reg} from the initiating of the interrupt IRQ to its processing within the microcontroller μC, there lasts a period Δtₐ* in which the load M is in an active state without monitoring by the microcontroller μC. Thereafter, from the instant t_{W}, the microcontroller μC will have been switched to the active state μCᵣᵤₙ. A new period T_{μCrun} begins, and from now on the states of all the loads M connected to said microcontroller μC are therefore checked. Thus one or more in particular safety-relevant loads M can be rapidly checked for their relevant switching state.

A maximum time interval provided for this checking is shown as At in the drawing in FIG. 2. In this example the time interval At is less than the period T_{μCrun} during which the microcontroller μC with monitoring tasks remains switched to the active state μCᵣᵤₙ. Within the time interval Δt the microcontroller μC can deactivate the load M again at any instant and therefore terminate the period Tₐ*. Switching times of some 400 ms necessary for reliably switching a central locking system are not reached, as each measurement for a safety-relevant load M lasts only a few milliseconds. In particular, however, Δt is less than the heating-up period Δt_{d} described in connection with FIG. 5, after the elapse of which damage to electrical components due to overheating is a possibility.

In an alternative embodiment of the invention, a control loop intervenes via control commands in accordance with the controller area network standard, or CAN for short. On the basis, for example, of a two-wire circuit, control commands according to the CAN standard, so-called CAN messages, are sent via a data network. These control commands are read by all the devices connected to this bus, but evaluated only by the particular device addressed, it being additionally possible in each case to emphasize the importance of a message by selecting a priority level. A high priority of a CAN message initiated by the disturbance S and the associated state change guarantees an immediate reaction by the microcontroller μC once it has been started up or has attained the state μCᵣᵤₙ. When the processing time interval Δt_{reg} has elapsed, the load M can therefore be immediately transferred again, in a defined manner, from the active state to the deactivated state with the fault condition having been eliminated.

Fault states triggered by external electromagnetic interference or, with tampering intent, by high-energy pulses, can therefore be quickly detected and reliably eliminated. However, in addition to externally caused fault states, malfunctions which can no longer be actively corrected by the microcontroller μC itself may also occur in a vehicle. Such fault states include e.g. faults in the microcontroller μC itself. They may occur in the form of failed gates or ports in the microcontroller μC. However, in the case of a rewritable electronic device used as a microcontroller μC, errors may additionally be present in its programming because of a phenomenon known as “moving bits”. In the first case the microcontroller μC is itself defective and can only be replaced, while in the second case the problem can be remedied by reprogramming. In both cases, however, the microcontroller μC can no longer eliminate the fault states.

Also cabling or cable harness faults at the load M to be switched when the load M is shorted to ground GND e.g. by a supply voltage +U_{bat} can be detected but not eliminated by the microcontroller μC. For this purpose, the diagram in FIG. 3 shows a circuit 1 having a control unit SG and a vehicle electrical system control unit BS for actuating a motor M, the control unit being superordinate to the microcontroller μC (not shown). The motor M here has a short-circuit to ground as a suddenly arising fault state. As a result of the diagnostics triggered by the state change on the basis of the diagnostic signal Diag, this serious fault state at the load M is detected. It is therefore also established that the fault cannot be eliminated by the microcontroller μC. According to this classification of the fault, a fault message is fed out by the control unit SG via the data bus and causes the vehicle electrical system control unit BS to remedy the situation by disconnecting the supply voltage of the defective circuit and activating a fault indication.

Rapid and reliable implementation of the CAN message is ensured within the depicted vehicle electrical system section by the fact that, according to the CAN standard, messages can be assigned different priorities. For fault states in safety-relevant areas, a high priority can therefore be preset, thereby enabling system protection measures to be selectively initiated, here namely deactivation of the defective load by actively disconnecting the corresponding circuit, as the microcontroller μC cannot eliminate this fault. In the present case as illustrated in FIG. 3, the high-priority CAN message therefore reads: “Shut down power supply of motor M immediately.” This message is executed in each case and implemented on a priority basis. This means that not only cable fires or control unit fires but also battery discharge can be quickly and effectively avoided.

Altogether a reliable method of increasing the safety of operation of electrical components has therefore been implemented above, a method based on monitoring unintended state changes of critical loads. Also with a method according to the invention, the microcontroller or a superordinate control unit does not need to be permanently operated in an active run mode. This constitutes an additional safety function whose implementation does not significantly increase the power consumption of the controlling electronic unit. However, safety of operation has been considerably increased, with the equipment cost/complexity remaining altogether virtually unchanged. Implementation can be reliably performed by different coding via interrupts or via CAN messages.

By extending the evaluating and analyzing capabilities of a microcontroller μC and/or of a superordinate control unit SG, the possible applications discussed can be used cumulatively on a redundancy basis for known safety methods for increasing overall safety e.g. in a vehicle, the costs for additional hardware being essentially limited to a microcontroller chip which, however, is already provided as a component in safety devices of the above type. Retrofitting can therefore also be performed in the form of swapping out a microcontroller as a standardized electronic component in which hardware now additionally required can be incorporated.

I claim:

1. A method for increasing the safety of operation of an electrical component, in particular of electrical components in a vehicle, comprising the steps of:
actuating a load via a microcontroller,
detecting actively a change in the switching state of a relevant load, and
performing diagnostics irrespective of the instant of actuation of the load by the microcontroller and/or by a superordinate control unit.

2. The method according to claim 1, wherein a diagnostic feedback is applied to a wake-up interrupt input of the microcontroller.

3. The method according to claim 1, wherein a diagnostic feedback is applied to an input for a non-maskable interrupt as diagnostic readback port.

4. The method according to claim 1, wherein switch-in or disconnection of a load is performed by a vehicle electrical system control unit, wherein a central locking motor preferably being actuated as the load.

5. The method according to claim 1, wherein diagnostic means are used to determine whether a fault state can be eliminated by the microcontroller, wherein remedial action being initiated by a superordinate control unit if the microcontroller fails.

6. A device for increasing the safety of operation of an electrical component in a circuit, particularly of electrical components in a vehicle, wherein a load is connected to a microcontroller for actuation, comprising means of actively detecting a change in switching state of the load which are designed to act, independently of the instant of active triggering of a microcontroller, upon the microcontroller and/or a superordinate control unit.

7. The device according to claim 6, wherein the device further comprises:
means for actuating a load via a microcontroller, and
means for performing diagnostics irrespective of the instant of actuation of the load by the microcontroller and/or by a superordinate control unit.

8. The device according to claim 6, comprising a vehicle electrical system control unit for switching in or disconnecting the load as specified by the microcontroller.

9. The device according to claim 6, wherein the additional hardware compared to known system is essentially combined in the microcontroller.

10. The device according to claim 6, wherein diagnostic means are provided for identifying a fault state which cannot be eliminated by the microcontroller, and wherein said diagnostic can also take remedial action.

11. A device for increasing the safety of operation of an electrical component, in particular of electrical components in a vehicle, comprising:
means for actuating a load via a microcontroller,
means for detecting actively a change in the switching state of a relevant load, and
means for performing diagnostics irrespective of the instant of actuation of the load by the microcontroller and/or by a superordinate control unit.

12. The device according to claim 11, wherein a diagnostic feedback is applied to a wake-up interrupt input of the microcontroller.

13. The device according to claim 11, wherein a diagnostic feedback is applied to an input for a non-maskable interrupt as diagnostic readback port.

14. The device according to claim 11, comprising a vehicle electrical system control unit for switch-in or disconnection of a load, and a central locking motor preferably being actuated as the load.

15. The device according to claim 11, comprising a superordinate control unit coupled with said means for performing diagnostic to determine whether a fault state can be eliminated by the microcontroller, wherein remedial action being initiated by the superordinate control unit if the microcontroller fails.
